(19) United States
(12) Patent Application Publication
(10) Pub. No.: US 2017/0193144 A1
(43) Pub. Date: Jul. 6, 2017

(54) ASYNCHRONOUS SIMULATION STEERING SYSTEM

(71) Applicant: Purdue Research Foundation, West Lafayette, IN (US)

(72) Inventors: Sungahn Ko, Ulsan (KR); Lars Niklas Elmqvist, Annapolis, MD (US); David Scott Ebert, West Lafayette, IN (US)

(73) Assignee: Purdue Research Foundation, West Lafayette, IN (US)

(21) Appl. No.: 15/396,387

(22) Filed: Dec. 30, 2016

Related U.S. Application Data
(60) Provisional application No. 62/273,367, filed on Dec. 30, 2015.

(51) Int. Cl. G06F 17/50; G06T 11/20

(52) U.S. Cl. CPC G06F 17/5009; G06T 11/206; G06F 17/11

(57) ABSTRACT

A system which receives a plurality of high-fidelity simulation data models that together form an asynchronous simulation pipeline, determines low-fidelity approximations of the received simulation data models using local simulation proxies, and displays the approximations on a display for a user to enable the user to interactively configure a simulation run.

### CROSS REFERENCE TO RELATED APPLICATIONS

The present U.S. patent application is related to and claims the priority benefit of U.S. Provisional Patent Application Ser. No. 62/273,367, filed Dec. 30, 2015, the contents of which are hereby incorporated by reference in their entirety into the present disclosure.

### STATEMENT REGARDING GOVERNMENT FUNDING

This invention was made with government support under 2009-ST-061-CI0001-02 awarded by the Department of Homeland Security. The government has certain rights in the invention.

### TECHNICAL FIELD

The present application relates to computer simulation systems, and more specifically, to an interactive computational steering system for asynchronous simulations.

### BACKGROUND

Highways, interstates, and county roads; water mains, power grids, and telecom networks; offices, restaurants, and grocery stores; sewage, landfills, and garbage disposal. All of these are critical components of the societal infrastructure that help run our world. However, the complex and potentially fragile interrelationships connecting these components also mean that this critical infrastructure is vulnerable to both natural and man-made threats: twisters, hurricanes, and flash floods; traffic, road blocks, and pile-up collisions; disease, food poisoning, and major pandemics; crime, riots, and terrorist attacks. How can a modern society protect its critical infrastructure against such a diverse range of threats? How can we design for resilience and preparedness when perturbation in one seemingly minor aspect of our infrastructure may have vast and far-reaching impacts across society as a whole? Simulation, where a real-world process is modeled and studied over time, is a tool for analysts and policymakers to answer such questions. Using complex simulations of critical infrastructure components, expert users have been able to create “whatif” scenarios, calculate the impact of a threat depending on its severity, and find optimal mitigation measures to address them. In fact, analysts have gone so far as to name simulation as the “new innovation”: instead of endeavoring to produce the perfect solution once and for all, this new school of thought is to create a whole range of possible solutions and determine the optimal one using modeling and simulation. For example, during the Obama 2012 reelection campaign, it was reported that Organizing for Action data analysts ran a total of 62,000 simulations to determine voter behavior based on data from social media, political advertisements, and polling. Basically, the philosophy with big data analytics driven by simulation is not to get the answer perfectly right, but to be “less wrong over time”. Put differently, while it would be inappropriate to state—as others have done—that big data will ever overtake theory, it is clear that large-scale simulation is a new and powerful tool for making sense of the world we inhabit. Applying simulation to the scope of entire critical infrastructures—such as transportation, supply chains, and power grids—as well as the factors impacting them—such as weather, traffic, and man made threats—requires constructing large asynchronous simulation pipelines, where the output of one or more simulation models becomes the input for one or more other simulations arranged in a sequence with feedback. Such a system-of-systems (SoS) will enable leveraging existing high-fidelity simulation models without having to create new ones from scratch. However, this approach is still plagued by several major challenges that all arise from the complexity of chaining together multiple simulations in this way: monolithic simulations that are designed to be used in isolation, complex configurations for each model, non-standard data exchange for passing data between them, long execution times for each individual simulation that are not amenable to interactive visual analytics, and uncertain and inaccurate simulations compounded by their composition.

The potential for applying visual analytics to simulation involves not only efficiently presenting the results of a simulation to the analyst, but also building and validating large-scale and complex simulation models. For example, prior art studies have shown that visual analytics can reduce the number of simulation runs by enabling users to concentrate on interesting aspects of the data. Others have applied visual analytics techniques to support exploration of spatiotemporal models with kernel density estimation and cumulative summation. This approach has also been applied to epidemic modeling and decision impact evaluation. Other research has proposed a comprehensive visual analytics environment that includes interactive visual interfaces for spatial modeling libraries, including selection, adjustment, and evaluation. The system and methods of the present disclosure are different from these prior art systems in that the present disclosure combines multiple components in a simulation pipeline, where each stage in the pipeline provides visualization for analysis.

Supply chain management is another multi-decisional context where what-if analyses are often conducted to capture provenance and processes of supplies. Simulation is recognized as a great benefit to improve supply chain management, providing analysis and evaluation of operational decisions in the supply process in advance. With the IBM Supply Chain Simulator (SCS) [9] and enterprise resource planning (ERP), IBM is able to visualize and optimize nodes as well as relations in the supply chain. Perez also developed a supply chain model snapshot with Tableau. However, existing visualizations of supply chains are mostly limited to either local supply nodes or a metric model rather than managing the overall supply process.

Computational steering refers to providing user control over running computations, such as simulations. Computational steering may be classified as model exploration, algorithm experimentation, and performance optimization. Applications include computational fluid dynamics (CFD), program and resource steering systems, and high performance computing (HPC) platforms.

For all of the above applications, the user interface is a crucial component that interprets user manipulation for configuring data, algorithms, and parameters. Controlling, configuring, and visualizing such computational steering mechanisms is an active research area which needs further development.

### SUMMARY

The present disclosure provides, a visual analytics platform for interactive decision making and computational steering of various types of largescale simulation pipelines based on a visual analytics approach, herein referred to as VASA (Visual Analytics for Simulation-based Action). The VASA Workbench application itself is an interactive desktop application that binds together a configurable pipeline of distributed simulation components. It enables the analyst to visually integrate, explore, and compare the inter-related and cascading effects of systems of systems components and potential final alternative outcomes. This is achieved by visualizing both intermediate and final results from the simulation components using a main spatiotemporal view as well as multiple secondary views. The tool provides an interface for the analyst to navigate in time, including stepping backwards and forwards, playing back an event sequence, jumping to a particular point in time, adding events and threats to the timeline, and initiating mitigation measures. Moreover, it allows them to select between or combine different ensemble outputs from one simulation to be fed to other SoS components and explore consequences. Using this interface, an analyst could for example add a weather event (e.g., either an existing hurricane from a historical database, the union of several output paths, or simulation of a new one) to a particular time, and then step forward a week to see its impact on roads, power, and food distribution.

The simulation components provide the main functionality to the VASA platform. Each simulation component communicates with the Workbench using a representational state transfer (REST) API that standardizes the data and parameter exchange. The data flows and parameters passed in the pipeline can be configured in the Workbench application using a graphical interface. Furthermore, the Workbench also includes a local simulation proxy for each remote simulation component that provides real-time approximations of each simulation model to enable using them for interactive visual discourse. This feature also provides the computational steering functionality of the Workbench: after configuring a simulation run in an interactive fashion, the analyst can launch the (possibly lengthy) execution from the Workbench. The Workbench then provides tools to manage the simulation pipeline, for example to prematurely shut down a simulation component to accept a partial result, skip a run, or rerun a component with new parameters.

The system of the present disclosure may be applied to supply chain management of food systems, and provides an initial working example of a food production to restaurant system. The system may further be implemented to simulate weather (including storms, hurricanes, and flooding), the power grid, supply chains, transportation, and food poisoning. The present disclosure describes these individual components and then present an example of how the VASA platform can be used to explore a whatif scenario involving a major hurricane sweeping North Carolina and knocking out a large portion of the road networks and power grid. The present disclosure further illustrates how the VASA system can be used to simulate food contamination outbreaks and how this information can be used to track back the contaminated products to the original distribution centers.

According to one aspect, the present disclosure provides a system for steering asynchronous simulation data, comprising a computer processing unit, a digital memory, and an electronic display, the computer processing unit and the digital memory configured to receive a plurality of high-fidelity simulation data models that together form an asynchronous simulation pipeline, determine low-fidelity approximations of the received simulation data models using local simulation proxies, display the approximations on a display for a user to enable the user to interactively configure a simulation run.

According to another aspect, the present disclosure provides a method of steering asynchronous simulation data, comprising receiving a plurality of high-fidelity simulation data models that together form an asynchronous simulation pipeline, determining low-fidelity approximations of the received simulation data models using local simulation proxies, and displaying the approximations on a display for a user to enable the user to interactively configure a simulation run.

### BRIEF DESCRIPTION OF THE DRAWINGS

The above and other objects, features, and advantages of the present invention will become more apparent when taken in conjunction with the following description and drawings wherein identical reference numerals have been used, where possible, to designate identical features that are common to the figures, and wherein:

FIG. 1 depicts a system for simulating pipelines for societal infrastructure according to one embodiment.

FIG. 2 depicts a user interface for the system of FIG. 1 according to one embodiment.

FIG. 3 depicts a critical infrastructure server containing a pre-computed ensemble database and Vu environment with simulation submodels according to one embodiment.

FIG. 4 depicts a power transmission grid with parts of the distribution network.

FIG. 5 depicts a transportation network including transportation facilities.

FIG. 6 depicts one example simulation where power generation units are impacted by a hurricane.

FIG. 7 depicts how a reduced number of facilities could have been impacted based on a reduced hurricane wind speed.

FIG. 8 depicts a hotspot visualization of food contamination over a geographical map.

FIG. 9 depicts a data processing portion of the system of FIG. 1 according to one embodiment.

The attached drawings are for purposes of illustration and are not necessarily to scale.

### DETAILED DESCRIPTION

In the following description, some aspects will be described in terms that would ordinarily be implemented as software programs. Those skilled in the art will readily recognize that the equivalent of such software can also be constructed in hardware, firmware, or micro-code. Because data-manipulation algorithms and systems are well known, the present description will be directed in particular to algorithms and systems forming part of, or cooperating more directly with, systems and methods described herein. Other aspects of such algorithms and systems, and hardware or software for producing and otherwise processing the signals involved therewith, not specifically shown or described herein, are selected from such systems, algorithms, components, and elements known in the art. Given the systems and methods as described herein, software not specifically shown, suggested, or described herein that is useful for implementation of any aspect is conventional and within the ordinary skill in such arts.

Computational steering is defined as user intervention in an autonomous process to change its outcome. This approach is commonly utilized in visual analytics when embedding a human analyst into the computation loop for the purpose of creating synergies between the analyst and computational methods. In the present disclosure, the autonomous processes evaluated are simulation models (often based on discrete event models) that are chained together into asynchronous simulation pipelines where the output of one or several simulations becomes the input to one or several other simulations. Such a simulation pipeline is also a system-of-systems (SoS): multiple heterogeneous systems that are combined into a unified, more complex system whose sum is greater than its constituent parts. Synthesizing all these components yields the concept of visual analytics for steering system-of-system simulations: the use of visual interfaces to guide composite simulation pipelines for supporting sense-making and decision-making. In the present disclosure, this concept is applied to modeling societal infrastructure, such as transportation, power, computer networks, and supply chains. Below we explore the design space of this concept, including problem domains, users, tasks, and challenges. We then derive preliminary guidelines for designing methods supporting the concept.

3.1 Domain, User, and Task Analysis

The concept of creating large-scale system-of-system simulation pipelines is applicable to a wide array of problem domains, including:
Supply chain logistics: Impact of large-scale weather events on the distribution of goods (particularly perishables, e.g., food).
Public safety: Crime, riots, and terrorist attacks on critical infrastructure, such as on roads, bridges, or the power grid.
Food safety: Incidence, spread, and causes of food contamination, often due to weather (power outage) or transport delays.
Cybersecurity: Societal impact of cybersecurity attacks, such as on power stations, phone switches, and data centers.

The intended audience for computational steering of simulation models using visual analytics is what we call “casual experts:” users with deep expertise in a particular application domain, such as transportation, supply chain, or homeland security, but with limited knowledge of simulation, data analysis, and statistics. Their specific background depends on the problem domain; for example, they may be logistics analysts for supply chain applications, police officers for public safety, and homeland security officials for food safety and cybersecurity. Because of this “casual” approach—a term we borrow from Pousman et al.'s work on casual information visualization—our intended users are motivated by solving concrete problems in their application domain, but are not necessarily interested in configuring complex simulation models and navigating massive simulation results.

Even if our primary audience is these casual experts, it is likely that the outcome of a simulation analysis will be disseminated to managers, stakeholders, or even the general public. Thus, a secondary user group for consuming our analysis products is laypersons with an even more limited knowledge in mathematics, statistics, and data graphics.

In our particular application, we identified tasks for simulation steering by working with a group of analysts from a restaurant chain that has a very large number of restaurants across the U.S., as well as a food supply chain involving farms, food processing centers, and food distribution centers. The two main concerns voiced by these analysts are better understanding and traceability of their supply chain and understanding resiliency/vulnerability of their food supply network, especially in relation to pertain to severe weather and food poisoning: understanding the impact of natural disasters (e.g., hurricanes) on their food supply chain, processing facilities, and restaurants, as well as determining the source and distribution of food contamination cases in relation to their restaurants. More specifically, our analyst audience wants to perform the following high-level tasks in relation to these two concerns:
Increasing preparedness for potential scenarios;
Improving the resilience of the restaurant chain; and
Planning for mitigation and response to a situation.

A motivating example for our target analysts is to understand the impact of severe weather (e.g., hurricanes) on power plants and roads, which may directly or indirectly impact food processing centers, distribution centers, and restaurants. Direct impacts include power outages, flooding, and evacuation. Indirect impacts, on the other hand, occur due to direct impacts earlier in the supply chain, such as a farms, food processing or distribution centers going offline causing shortages and redistribution of products. Both types of impacts may cause closing of facilities which in turn may lead to indirect impacts downstream in the supply chain. Detecting such closures allows the analysts to mitigate their impact, for example by rerouting deliveries from other distribution centers, or even transporting back frozen products from a restaurant lacking refrigeration due to an extended power outage. In a hurricane scenario, the primary task then becomes determining which facilities will be closed, which routes will be impassible, and the impacts and duration these will have throughout the supply chain. Similar effects can be caused by power failures caused by other events (e.g., severe summer demand, tornadoes, power grid cyberattacks). These failures can also impact food safety due to spoilage and conditions favorable for contamination. If this is not prevented, it leads to the second task named by our target analysts: the capability to model food contamination and backtrack to its source so that the contamination can be stopped. Similar to the hurricane example above, this also requires coordinating multiple interdependent simulation models. Unfortunately, our user group does not currently have tools for performing a series of simulations to explore these scenarios.

3.2 Challenges

Modeling the real world is a tremendously difficult and error-prone process. However, we leave concerns about the fidelity, accuracy, and quality of a simulation to researchers from the simulation field. Rather, in this subsection we concern ourselves with the challenges intrinsic to connecting multiple individual simulation models into large-scale pipelines. In the context of simulation steering for such pipelines, we identify the following main challenges from our analyst audience:

C1 Monolithic simulations: While individual high-fidelity simulation models exist for all of the above components and threats, these models are monolithic and not designed to work together.

C2 Complex relationships: Each high-fidelity simulation model consists of a plethora of parameters and controls that require expertise and training, which is exacerbated when several such models are combined into a single model.

C3 Non-standard data: No standardized data exchange formats exist for passing the output of one simulation model, such as for weather, as input to another model, such as supply chain routing.

C4 Long execution times: Most state-of-the-art, high-fidelity simulation models require a non-trivial execution time, often on the order of minutes, if not hours. Such time frames are not amenable for real-time updates and interactive exploration.

C5 Uncertainty and fidelity: Chaining together multiple simulations into a pipeline may yield systematically increasing errors as uncertain output from one model is used as input to another. This is compounded by the fact that heterogeneous simulation models may have different levels of fidelity and accuracy.

3.3 Design Guidelines

Based on our review of the problem domain, users, and tasks above, as well as the challenges that these generate, we formulate the following tentative guidelines for designing visual analytics methods for steering system-of-system simulation pipelines:

G1 Simulations as standardized network services: Distributing simulation models as network services avoids the trouble of integrating a monolithic design with another system (C1) and automatically provides a data exchange format (C3). The simulations also become decoupled, which means they can be parallelized and/or distributed in the cloud to manage long execution times (C4).

G2 Simulation proxies for interactive response: Meaningful sensemaking in pursuit of one of the high-level tasks in Section 3.1 requires real-time response to all interactive queries. This means that long execution times (C4) of simulation models in the pipeline should be hidden from the user. We propose the concept of a simulation proxy as an approximation of a remote simulation service that is local and capable of providing real-time response at the cost of reduced (often significantly) accuracy. G3 Visual and configurable relationships: The interactive visual interfaces routinely employed in visual analytics may help to simplify and expose the complex configurations necessary for many high-fidelity simulation models (C2), even for non-expert users.

G4 Partial and interruptible computational steering: Once an analyst has configured a simulation run using simulation proxies (G2) and visual mappings (G3), the full simulation pipeline must be invoked to calculate an accurate result. A full-fledged simulation run may take minutes, sometimes hours, to complete. The computational steering mechanisms provided by the software should provide methods for continually returning partial results [14] as well as interrupting a run halfway through.

G5 Visual representations of both intermediate and final results: To fully leverage the power of visual analytics, we suggest using interactive visual representations of simulation results. Such visualizations should be used for both intermediate data generated by a simulation component anywhere in the pipeline—which would support partial results and interrupting a run at any time—as well as for the final results. All visual representations should be designed with uncertainty in mind (C5), and providing intermediate visualizations should also help in exposing propagation of increasing error. Finally, it may also be useful to use visual representations for the approximations created by simulation proxies (G2), but these should be clearly indicated as such.

G6 Spatiotemporal focus: The primary data dimension of interest for results from simulation pipelines has both spatial and temporal attributes; for this reason, we will base the visual analytics interface on spatiotemporal visualization. Secondary visualizations may focus exclusively on time, space, or quantities.

### 4 VASA: OVERVIEW

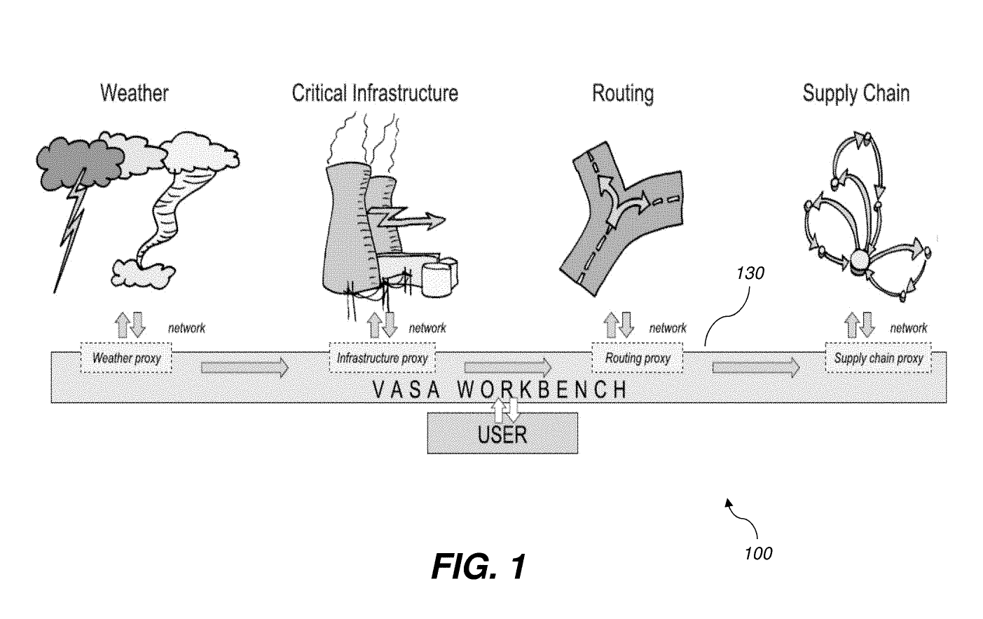

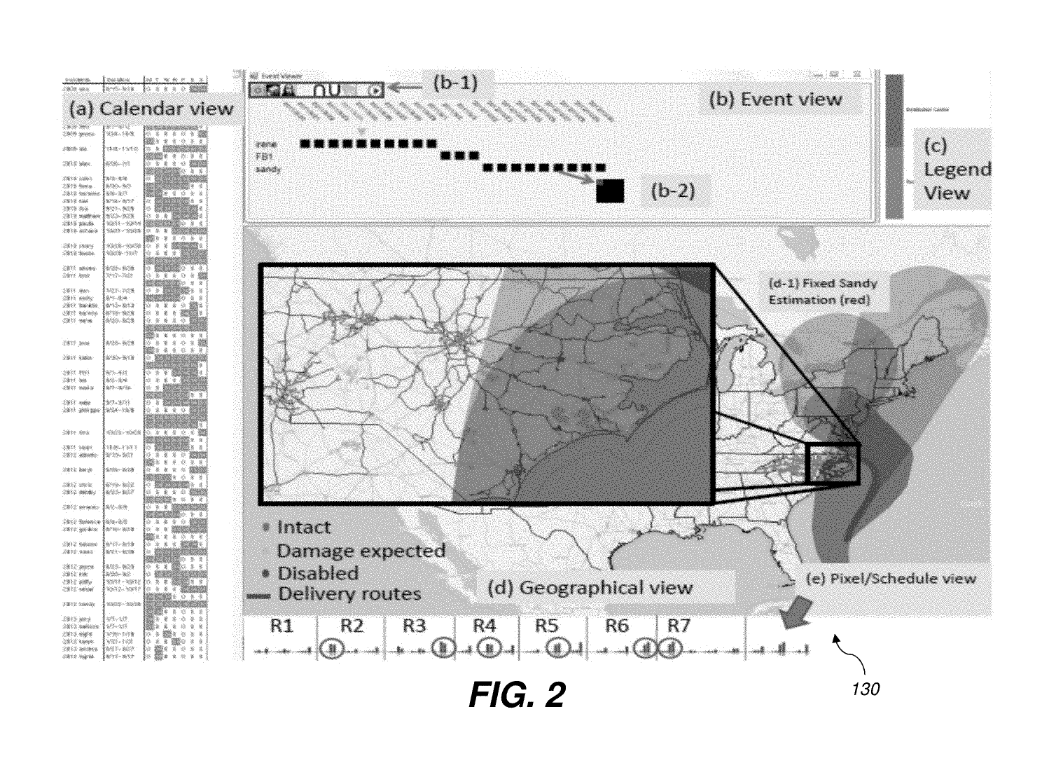

FIG. 1 illustrates conceptual model of one embodiment of a distributed component-based system 100, herein referred to as VASA (Visual Analytics for Simulation-based Action), for steering system-of-system simulations for societal infrastructure. At the center of the system is a user-driven computer interface 130, herein referred to as the VASAWorkbench (See also FIG. 2), for configuring, steering, and exploring simulation models, impacts, and courses of action. The interface 130 provides a visual analytics dashboard based on multiple coordinated views, an event configuration view, and a computational steering view. The workflow of the interface 130 revolves around initiating, controlling, analyzing, exploring, and handling events from the remote simulation components as well as the local simulation proxies.

Within the dashboard of the interface 130, events are displayed in a selectable calendar view (a) where each event's name, dates and a user-selected representative attribute (e.g., storm's maximum wind speed) are shown. The selected events from (a) are listed chronologically in the event viewer (b), where a user can select times for investigation. A toolbar (b-1) provides buttons for initiating simulations (e.g., cyberattack, storm simulations, distribution re-routing), selecting combinations of events (union, intersection, difference), selecting event visualization modes (polygons, contours), and triggering chronological playback.

Users can select a time within an event for comparison (in one example, by rightclicking on a event's black rectangle), causing a red mark to be shown in the upper right corner of the associated event (b-2), and the corresponding impact to be highlighted in the main geospatial view (d-1, Sandy, red). This allows for comparing across different events and effects. We provide a legend window (c) for selected properties and the geographical view (d) renders the simulation results, including event evolution, routing paths, and impacts on critical infrastructures. Several of the dashboard widgets are plugged in from the simulation components. For example, a food delivery schedule to each store within a supply chain is provided in (e) where the x-axis presents corresponds to different restaurants while the y-axis represents different food processing centers or different types of foods. Here, the darker the red, the larger the quantity of the delivered food. The quantity information is provided in a tooltip that helps a user to estimate possible losses. This view enables traceback analysis (e.g., which type of food was contaminated from which processing centers, how much contaminated food was delivered to which store, etc) for food contamination incidents.

### 5 VASA: COMPONENTS

The VASA suite currently provides four simulation components: weather, critical infrastructure, routing, and supply chains. Data from each component and proxy is processed and merged before being visualized in the Workbench. Each proxy not only processes and stores data for its own visualization but also communicates with other proxies upon request. For example, to visualize new delivery routes, the routing proxy asks the infrastructure proxy for impacted stores before approximating new routing information. In this way, the VASA system uses a loosely coupled state that is distributed across components and proxies. We review each of the VASA components below.

5.1 Weather Component

To provide analysts with a one-stop source for weather data, a server is implemented that asynchronously amasses data from on-line sources and presents it to clients through a RESTful web interface. This provides access to weather data—both historical, current, and modeled—through a singly authenticated VASA component. The service can be queried by the user or set into a push-mode to send new events to the VASA Workbench (interface 130) during severe weather season (e.g., hurricane, flood, tornado season, etc).

5.1.1 Simulation Model and Simulation Proxy

Beyond historical data, the VASA weather component currently collect both ADCIRC and NOAA weather models. The ADCIRC (Advanced CIRCulation) model is a collaboration of several research centers off the East and Gulf coasts of the United States. Active during hurricane season, these models are run every four hours when storms are presents, producing ADCIRC-formatted datasets at fixed intervals forward from the start point. These results are made publicly available using THREDDS and OPeNDAP for cataloging, discovery and data access. Similarly, NOAA produces wind-speed probabilities along the tracks of many types of storms as contours at 34, 50, and 64-knot levels. When updated datasets appear on the respective dissemination sites, we import them onto the VASA weather server, which provides a simple API to access the data in convenient multi-resolution formats.

The proxy in this component has two roles. The first role is to prepare all event datasets from the remote event server. Therefore, the system first checks for new updates from the server. If there is a new update, it retrieves the data and caches it on the local workbench for faster loading. The second role is to visualize new status of an event on the date that a user selected and notify the status change of the event to other proxies. An example status change is a user changing the start date of a hurricane in the event viewer. When this happens, the proxy visualizes a new state of the hurricane on that date and notifies this change to other components, which initiates work by downstream proxies (e.g., estimating an area without power and impassable roads).

For visualizing weather data, the user can select the visual representation either as polygons or as contours as shown in FIG. 2 (b-2, the last button). In polygonal mode, two probability models (blue with two different opacities) are projected as shown in the magnification view in FIG. 2. Here, the smaller polygon represents a predicted path with high probability, and a larger one represents a predicted path with low probability. When a user selects a hurricane, the hurricane turns red for comparison to other hurricane paths. For example, in FIG. 2 the paths of Hurricane Irene on Aug. 24, 2011 (blue) and Hurricane Sandy on Oct. 27, 2012 (red) are both rendered for comparison.

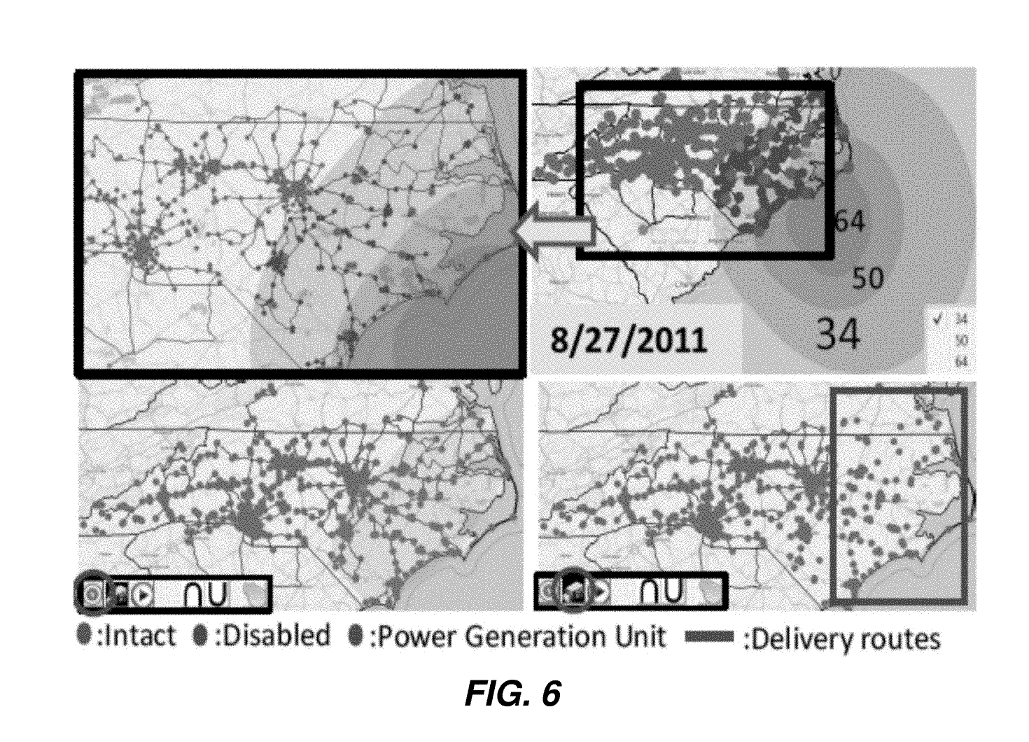

In contour mode, on the other hand, hurricanes are drawn using three different sizes of contours, each representing mean areas in different wind speeds (e.g., Hurricane Irene in our simulation model has 64 knot highest wind speed at the innermost contour, and 34 knot lowest wind speed at the outermost contour as shown in FIG. 6). To utilize different wind speeds in simulation steering, a user can set up a threshold for infrastructures (e.g., a power generation unit is disabled if the wind hitting the plant has speed higher than 34 knot). In addition, a user can apply one of the contours for a time. For example, FIG. 6 (top-right) presents which power generation units are affected when a contour with 34 knot hits the area. Here, red circles represent affected restaurants and purple circles represent power generation units supplying electricity to those restaurants.

5.1.2 Input and Output

The weather component often serves as a starting point for analysis by alerting severe weather conditions, and thus typically has no upstream component dependencies. Instead, simulation runs are often initiated by the analyst by adding weather events—current, modeled, or historical—to the timeline. Available weather events currently only include hurricanes, but are being expanded to other severe storm alerts, and are listed in a calendar view (FIG. 2(a)).

5.1.3 Implementation Notes

The VASA weather component is implemented as a web service accessed using the common VASA RESTful API. All data objects are represented by URLs that encode procedures and parameters that, when issued, return JSON objects containing the results. This provides a very simple interface for use both by browser-based visualization

UIs that use AJAX to issue requests asynchronously, and other platforms that provide access through language-specific interfaces.

5.2 Critical Infrastructure Component

Widespread emergencies such as hurricanes, flooding, or cyberattacks will often affect multiple societal infrastructures. High winds and flooding from a hurricane, for example, could knock out parts of the power grid, the effect of which would cascade to traffic signals, the communications network, the water system, and other infrastructures. The flooding might simultaneously make parts of the road network impassable. These breakdowns would affect critical facilities such as schools, hospitals, and government buildings. For longer-lived disasters, food distribution might break down due to power outage, route disruption, or other cascading effects. The purpose of VASA's critical infrastructure component is to simulate how such external emergencies, modeled in other components, will impact critical infrastructure.

5.2.1 Simulation Model and Proxy

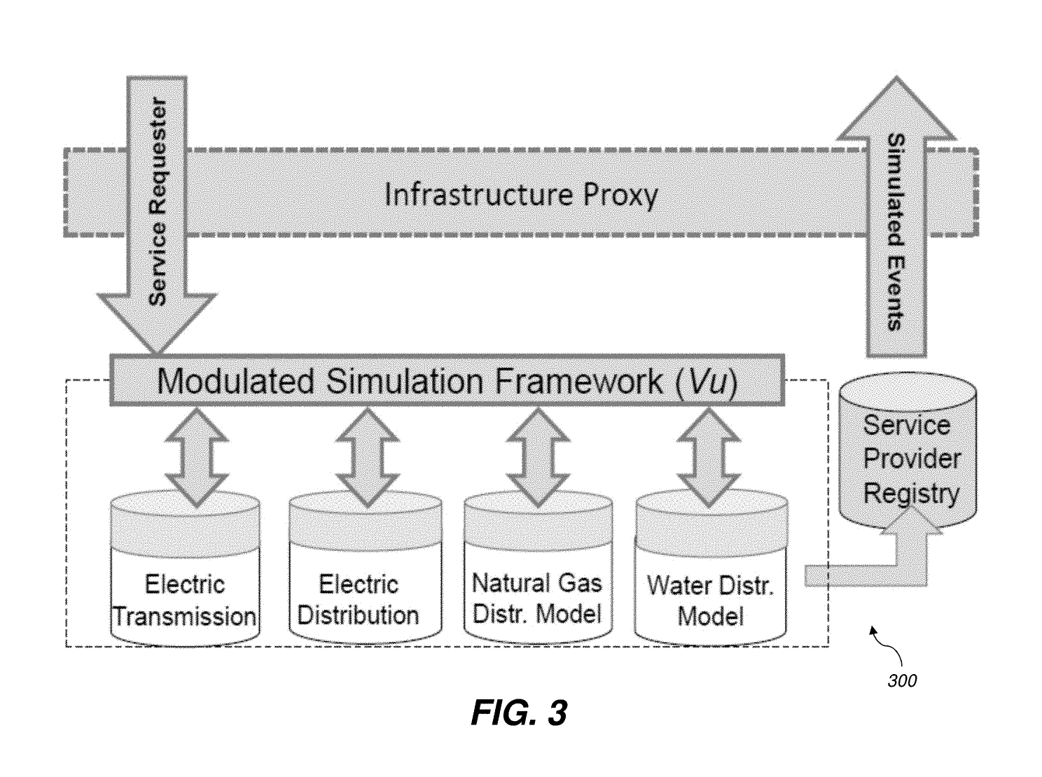

To capture these complex, multifarious, and dynamic effects, the VASA critical infrastructure component takes into account the interrelationships between critical infrastructure systems. The simulation is built within the Vu environment 300, which provides a knowledge-driven approach to integrated modeling and simulation of complex systems of systems. (FIG. 3), which provides a rule-based framework for integrating multiple infrastructure submodels at a high level. This results in an interdependency ontology. Thus, for example, a breakdown of a power substation would immediately cascade to power loss at points on its distribution network. If a school were a node in the distribution network, it would be switched to backup power that, after a given time, would also shut down. Likewise, telecommunication nodes would switch to backup power that might also shut down after its prescribed duration. There could also be outages due to power load imbalances at other points in the grid.

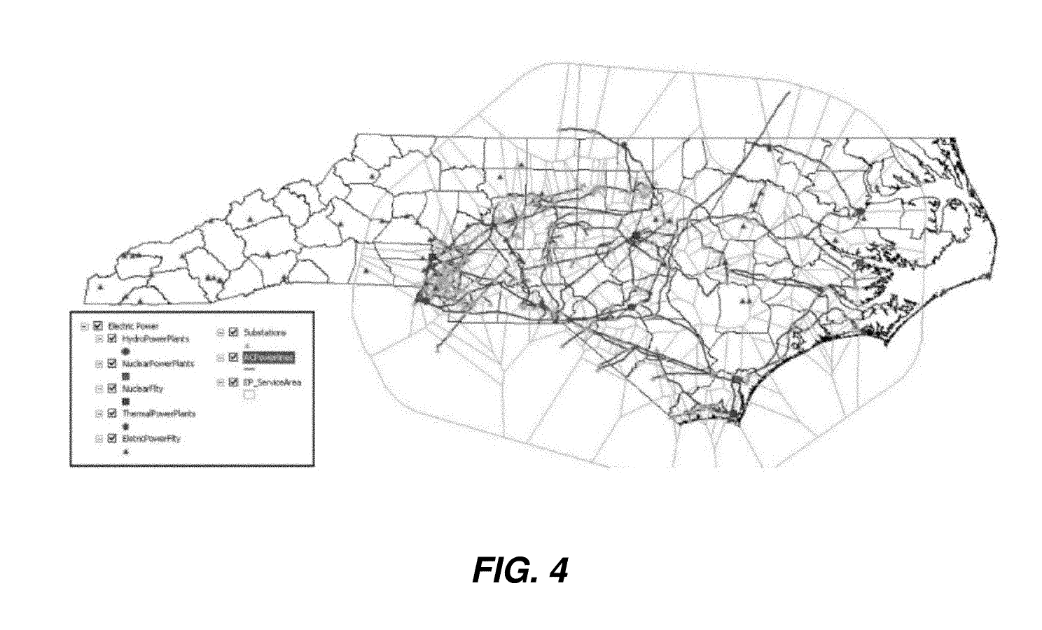

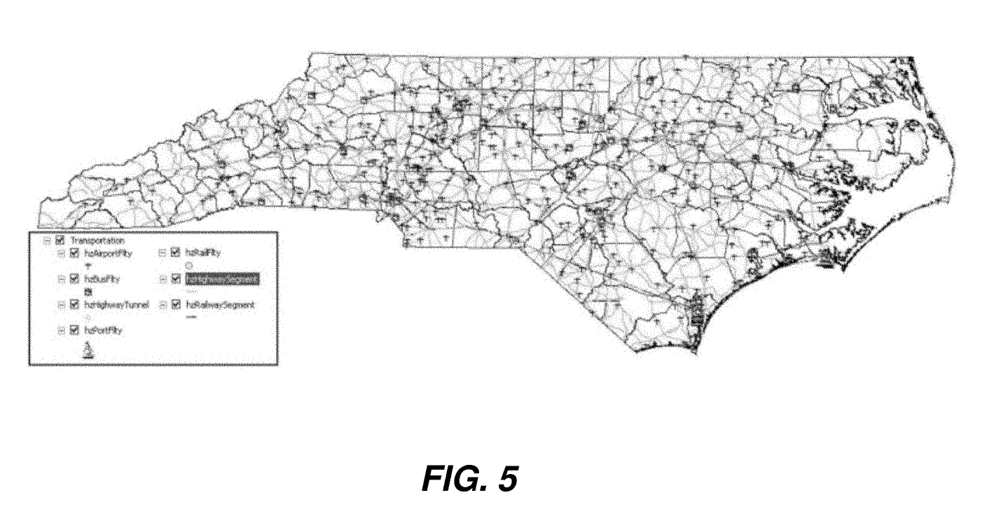

The infrastructures we currently model include the electric grid; the communications network including TV stations, radio stations, cellular switch controls, and cell towers; transportation facilities including airports, bus terminals, rail lines and terminals, bridges, tunnels, and ports; the road network including main and secondary roads; natural gas pipelines and pumping stations; critical facilities including fire stations, police stations, schools, hospitals, emergency care facilities, manufacturing locations, government buildings, and hazmat facilities. FIG. 4 shows the electric grid, which includes the complete transmission network down to substations for both North and South Carolina. Parts of the distribution network are also included, especially for critical installations. FIG. 5 shows the transportation network for North Carolina, including roads, airports, rail lines, etc. For the purposes of VASA, we have also added store and distribution center locations for a large food chain in North and South Carolina. These facilities are linked to the power grid and road networks.

The proxy for the critical infrastructure component maintains a simplified connectivity network of critical infrastructure. In this graph, restaurants are connected to the nearest plant. When the proxy receives a signal of a new event (e.g., storm path change, new day for approximation), it computes which infrastructures are affected by the event. For example, when a user moves the hurricane simulation forward to a new day, our proxy checks which infrastructures are newly affected and produces an estimate and its corresponding visualization (e.g., color changes for restaurants affected by power disruptions).

5.2.2 Input and Output

The primary inputs of this component comes from the weather component represented as polygons of severe weather, such as wind speed, precipitation, and temperature data. Furthermore, the component also accepts direct manipulation of simulation parameters for particular facilities from the Workbench itself, such as the user manually shutting down a power substation. The outputs returned from the component is a list of facilities (e.g., restaurants, food processing centers and distribution centers) that are closed, and a duration of their closures.

Our prototype system currently uses data from the state of North Carolina, and the data collection and organization process involves locating and identifying components of the various infrastructures for the state. We use publicly available data sources, in some cases identifying infrastructure components by indirect means. For example, comprehensive information about the electrical grid is closely held by the utility companies. However, we have shown our results to utility company officials and received confirmation as to their high accuracy.

5.2.3 Implementation Notes

As for all the other VASA simulation components, the system 100 uses a web service that can accept requests from the VASA Workbench and return simulation results ready to be presented in the user interface 130 (see FIG. 1). The critical infrastructure server itself has two components. One contains a searchable database of the pre-computed ensemble of simulation runs. The other accepts current storm path and other inputs from the weather component, converts them into courses of action, and computes a fresh set of cascading infrastructure disruption results via the Vu environment. When a request is issued via the user interface, the simulation proxy determines the weather inputs to send to the ensemble database component that immediately selects the closest ensemble simulation for use in the visual analysis. This proxy is then replaced by the more accurate result from the Vu model based on the current weather simulation as soon as it is available. Both the ensemble selection and the Vu model are depicted in FIG. 3. Therefore, an emergency response manager can make initial decisions based on the proxy and then refine them once the up-to-date result is available.

5.3 Supply Chain Component

Most food systems involve a number of firms from on-farm production of inputs through processing, distribution and retail sales. For the fast food system in VASA, three different firms have collaborated to provide the data on normal system performance: a vertically integrated poultry firm (hatchery to processed chicken), a warehouse and distribution firm, and a fast food restaurant firm. Each firm contributed data from their portion of the supply chain to enable modeling of product movement from farm to restaurant. The type of data provided includes geospatial information on the facilities involved (e.g., feed mills, hatcheries, poultry farms, poultry processing facilities, distribution centers and restaurants), normal transportation routes and scheduled times from each facility to the next facility in the system and details on actual shipment quantities on average (hatchery through processing) or actual shipment records for a limited time frame (distribution centers to restaurants). As an illustration of the amount of data that drives these systems, one week of data on product delivered from the two distribution centers to the nearly five hundred individual restaurants alone constitutes more than 120,000 individual records.

Hurricanes pose significant risks for normal supply chain operation from impassable roads, power outages, and floodings disrupting facility operation and distribution of products in the system. Understanding which routes and locations are likely to be at risk from a storm would enable a firm to develop contingency plans in advance of a storm, thus reducing operational losses immediately after a storm. Given that daily sales at larger fast food restaurants can be $4,300-$7,400, losses can mount quickly. For an impending storm or immediate aftermath, rerouting could enable firms to most efficiently maintain their distribution systems for both maintaining product distribution and retrieving food from restaurants without power to minimize spoilage losses.

5.3.1 Simulation Model and Proxy

The primary objective of the supply chain component is to model distribution of product from food processing plant, through food distribution center, and to the restaurants. The routing of transports are handled in another component (Section 5.4); however, a primary concern of this component is to track product for the purpose of food safety.

Food contamination can occur both intentionally or as a malicious act at any point in the supply chain and can result in significant public health consequences, from morbidity to mortality. While firms are required to have information one step forward and one step back in their supply chain, they often have difficulty gaining visibility beyond that. By gathering data from each step in the supply chain, it is possible to trace product from farm through to restaurant and from restaurant back to farm. Using data on actual lot sizes from the firms involved, two illustrative contamination scenarios were constructed to illustrate how differently seemingly similar contamination scenarios would transpire. This system also illustrated a common problem of “hidden nodes” in the system, i.e., facilities that one firm in the system does not realize are part of its supply chain. One of the poultry slaughter and processing facilities ships raw poultry to a further processing facility that then ships the resulting product to the distribution centers. If there were a contamination at the “blind” facility, neither the distribution firm for the restaurant firm would initially know that it was part of their supply chain. A contamination scenario builder is now under development that would enable users to model a wide range of contamination events and see how they would propagate through the supply chain.

Our simulation model can generate food-borne illness data based on an approach similar to the Sydovat [21] system. There are two major components of the model for generating synthetic illness data: temporal and spatial data. A time series is contructed from its individual components (day-of-week, interannual, interseasonal, and remainder) similar to seasonal trend decomposition. To generate the time series of food-borne illnesses for a user-injected restaurant location, the user defines the mean daily count of illnesses along with seasonal and day of week components. If historical data is available, then seasonal and day of week components can be selected from this historical data. Spatial locations for temporal data are generated based on the population density distribition in that area. The analyst can also customize the grid size and density distributions.

Our simulation proxy for the supply chain component maintains a low-fidelity representation of the transport network. This is used together with the weather polygons to approximate when a distribution center and store must shut down. For food poisoning scenarios, this inherently contains spatially-distributed points of ill people simulated based on the simulation model (Section 5.3.1). To visualize the spatial distribution and the hotspots of the poisoned people, the proxy in this component uses a modified variable kernel density estimation technique with varying scales of the parameter of estimation based upon the distance from a patient location to the kth nearest neighbor [34]. The model used for estimating the number of people poisoned is the same model utilized in Maciejewski et al., but we adjust parameters to consider different population densities in different regions.

5.3.2 Input and Output

This component accepts closures, including their durations, on supply chain facilities from the critical infrastructure component as well as severe weather polygons from the weather component. It then maintains and provides three types of information: (1) geo-information of all facilities of the supply chain, (2) delivery schedules, and (3) food products inventory in all locations (weight, size, and price).

5.3.3 Implementation Notes

The supply chain component is built in ArcGIS and Arc Network Modeler so that storm impacts can model solutions accounting for restaurants out of service (power, flooding) and impassable roadways.

5.4 Routing Component

The purpose of the routing component is to provide a mechanism for other VASA components to find appropriate routes from one facility to another given a dynamically changing world model, where roads may become impassable due to weather or other widespread emergencies.

5.4.1 Simulation Model and Proxy

The input to the routing component is a polygon representing an area impacted by severe weather (such as a hurricane). The component uses this input as a polygon barrier in the road network. Attributes of the road network are weighted to create a friction surface that iterates through routing options to determine the optimal route. The model does not currently include current traffic conditions or construction activity, but these factors could be added in the future. Each route minimizes the travel time between the distribution center and the first store or between stores. This set of routes represents the baseline scenario: how delivery trucks would travel under normal circumstances. Since delivery trucks can no longer reach outlets covered by the weather barrier, the routing service recomputes the routes with the barrier in place and returns new routes which avoid the outlets and roads covered by the barrier. If the barrier covers a distribution center, no deliveries will be made to outlets serviced by the center. The main focus of the proxy in the routing component is on approximating the number of routes that will be replaced if a complete simulation result exists. The proxy investigates which nodes in routes are expected to be disabled when there is an event. Then, after the investigation, it builds a polygon by connecting outer-most nodes and visualizes the polygon. This gives awareness to a user that the routes in the polygon are likely to be changed after a complete simulation.

5.4.2 Input and Output

The severe weather data is ingested into the component as GeoJSON objects from the weather simulation component. Similarly, the calculated routes are output as a set of large GeoJSON objects and sent back to the caller (most often the supply chain component). One important input in this component is the impact area provided by the workbench that is presented by a polygon. Once this input is received, this component recalculate routes for the area in the polygon. The geospatial database used by the component currently includes the addresses of two distribution centers and 505 fast-food outlets in our dataset, including the route information that links the centers to the outlets. This also includes the N shortest path routes, where N is the number of routes specified in the input data. The road network has a long list of attributes used to determine the shortest route, including road class, speed limit, number of lanes, and weight restrictions.

5.4.3 Implementation Notes

We implemented the routing component using ArcGIS Server 10.2 with the Network Analyst extension and the StreetMap Premium (TomTom North America data) road network. In general, the Esri suite of Geographical Information System (GIS) tools is widely used in a variety of industries and provides a robust set of tools and data. The server provides web-based services through REST endpoints and a robust API accessed with HTTPS GET or POST requests. The VASA workbench initiates a request to the routing service by providing a GeoJSON representation of the affected area. The affected area polygon is sent to Network Analyst Service to recalculate the route to traverse around the affected area. The response is two large GeoJSON objects containing a list of outlets no longer reachable, incremental travel time between stops, and the new route. Currently, the route processing requires 2-3 minutes to complete; this can be significantly improved in the future by commissioning a dedicated production server.

### 6 EXAMPLES

Here we demonstrate how the VASA system provides situational awareness using two examples: the impact of weather on macro-scale supply chains, and foodborne illness contamination and spread.

6.1 Supply Chains During Hurricane Season

Our first example is the potential impact of hurricanes on North Carolina's critical infrastructure, especially our food distribution network, in North Carolina (NC). Our exploration begins by selecting appropriate historial hurricanes for examination using the calendar view as shown in FIG. 2, where each hurricane name, duration, and selected summary attribute (e.g., maximum hurricane wind speed) are provided. While we investigate the paths of these historical hurricanes, we see that Irene in 2011 and Sandy in 2012 passed over NC. Because Sandy passed over only a small area in upper NC (FIG. 2 (d), red polygon), we choose to focus on Irene for further investigation.

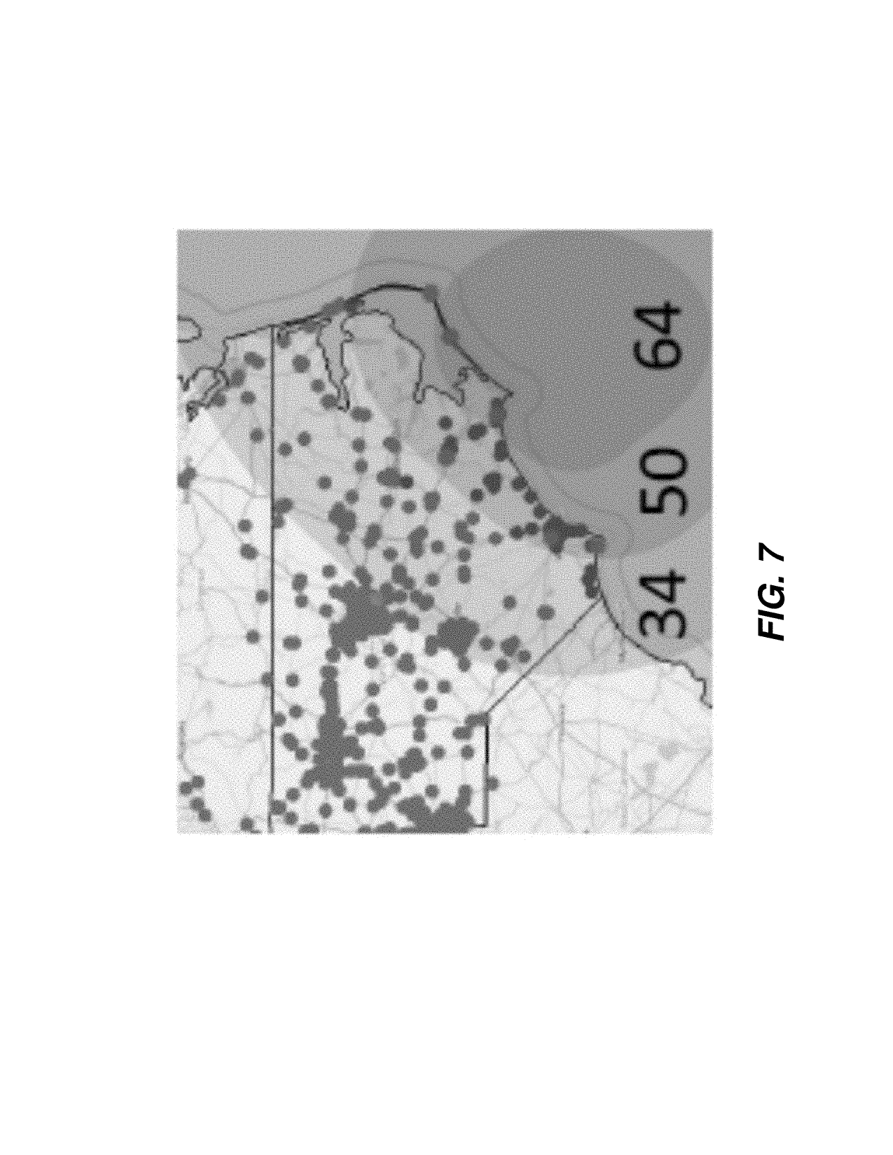

One interesting date is Aug. 27, 2011 when Irene passed directly over eastern North Carolina, an area with many power generation facilities as shown in FIG. 6 (top-right, purple circles). After we set up the wind tolerance value for these facilities to be 34 knots, our hurricane proxy instantly estimates which restaurants will be impacted based on the relationships between the units and the restaurants, coloring the impacted restaurants red. Here, we also initiated a complete simulation for power outages and transportation network damage. Next, a polygon is shown representing an area where restaurants are disabled and roads are blocked (bottom-left in FIG. 6). To efficiently manage distribution, this impact requires the food provider to change its delivery schedule, and this new routing is computed based on the impacted restaurant polygon and road conditions (e.g., blocked by flooding). After a simulation to compute the new routes (by clicking the truck button in a red circle, right-bottom FIG. 6), we see that the updated delivery paths do not include the affected restaurants. The economic loss caused by this event is estimated based on the model in Section 5.3 as being up to $1.13 million. Another possible what-if question is “How different would the result be if the power generation units could resist winds up to 50 knots?” FIG. 7 shows the first step of the analysis where we see many fewer restaurants affected compared to FIG. 6 top-right (units are resilient to 34 knots). In this case, the estimated losses are less than $333,000.

6.2 Fast Food Contamination

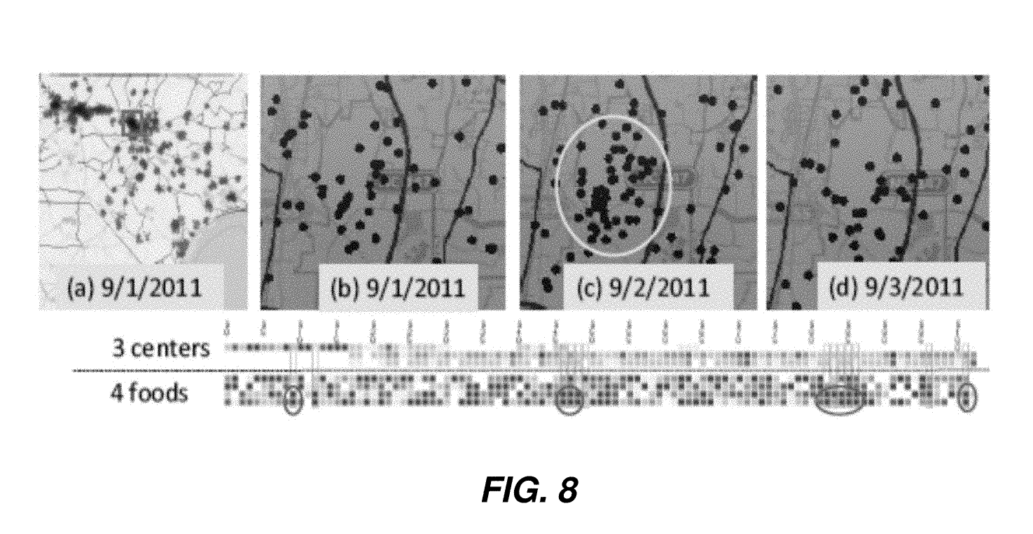

Food poisoning is an illness caused by eating contaminated food containing viruses, bacteria, and germ-generated toxins. There are many possible causes of food contamination including storage at inappropriate temperatures [19], improper food handling, and crosscontamination during processing or packaging. As unfortunately experienced several times per year, tracing back the cause of the contamination is a very difficult and lengthy process. In this example, we explore a hypothetical scenario demonstrating how VASA can be used to trace-back the root causes of an incident of foodborne illness. To create the distribution of the ill population, we simulate the distribution of contaminated food to stores, then simulate the illnesses in the neighboring areas using the simulation model discussed in Section 5.3. This creates the common base scenario of reports of people who are ill, their date of illness, and their location to create the food contamination scenario for the trace-back investigation. For example purposes, we simulated these illnesses occurring during a three day span (Sep. 1, 2011 to Sep. 3, 2011) as shown in FIG. 8. Since this is almost one week after Hurricane Irene, one may assume that power outages during the storm could be the possible reason behind the contamination. To confirm this hypothesis, we looked at the hot spots in FIG. 8 and identified the stores closest to these hot spots. On cross comparison, we can identify the common products/lots in those stores, their distribution center, as well as their delivery mechanisms. As shown in FIG. 8 bottom matrices, the rows represent 3 food processing centers and 4 types of food, and there is a column for each restaurant. Each cell is colored such that the darker the red color, the higher the amount of each product provided. Here, the restaurants in the affected area that are selected in the box in the top-left are highlighted with light green boxes. For stores S9 and S12, only one food processing center provided products, while other processing centers supplied most of the food throughout the network. Upon further inspection, one can determining that product lots in row 3 and 4 are common in most of the restaurants yielding ill individuals. Some example routes are shown in FIG. 2(e), where each route supplies 3-4 restaurants. A red bar represents the supplied food and the green bar represents the food consumed at a restaurant. Here, we see that a large amount of the third and fourth foods (blue circles in FIG. 2(e)) are delivered and will all be consumed within a few days. Therefore, these two product lots are good candidates for further inspection in tracing back the contaminated food item.

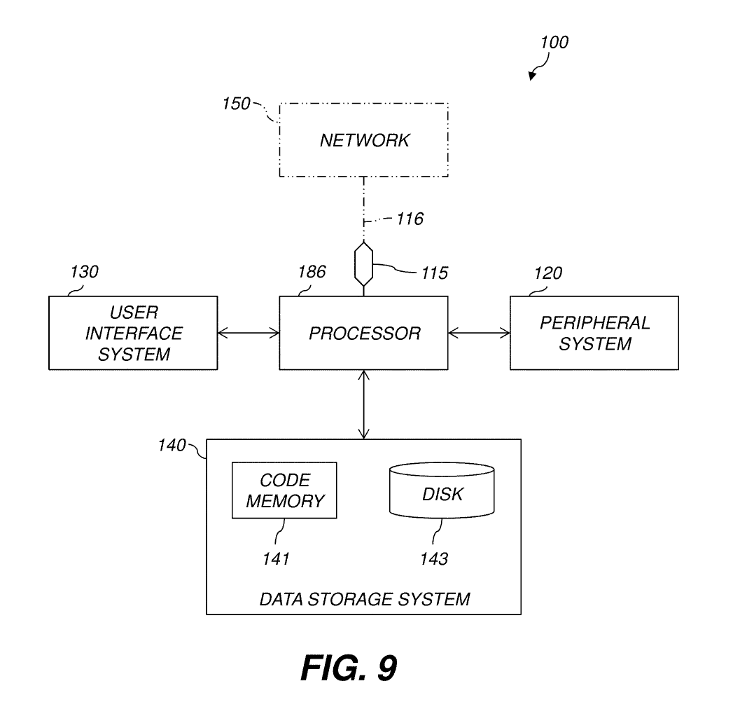

FIG. 9 is a high-level diagram showing the components of one example of the system 100 for analyzing data and performing other analyses described herein, and related components. The system 100 includes a processor 186, a peripheral system 120, a user interface system 130, and a data storage system 140. The peripheral system 120, the user interface system 130 and the data storage system 140 are communicatively connected to the processor 186. Processor 186 can be communicatively connected to network 150 (shown in phantom), e.g., the Internet or a leased line, as discussed below. It shall be understood that the system 120 may include multiple processors 186 and other components shown in FIG. 9. The simulation data described herein may be obtained using network 150 (from one or more data sources), peripheral system 120 and/or displayed using display units (included in user interface system 130) which can each include one or more of systems 186, 120, 130, 140, and can each connect to one or more network(s) 150. Processor 186, and other processing devices described herein, can each include one or more microprocessors, microcontrollers, field-programmable gate arrays (FPGAs), application-specific integrated circuits (ASICs), programmable logic devices (PLDs), programmable logic arrays (PLAs), programmable array logic devices (PALs), or digital signal processors (DSPs).

Processor 186 can implement processes of various aspects described herein. Processor 186 can be or include one or more device(s) for automatically operating on data, e.g., a central processing unit (CPU), microcontroller (MCU), desktop computer, laptop computer, mainframe computer, personal digital assistant, digital camera, cellular phone, smartphone, or any other device for processing data, managing data, or handling data, whether implemented with electrical, magnetic, optical, biological components, or otherwise. Processor 186 can include Harvard-architecture components, modified-Harvard-architecture components, or Von-Neumann-architecture components.

The phrase “communicatively connected” includes any type of connection, wired or wireless, for communicating data between devices or processors. These devices or processors can be located in physical proximity or not. For example, subsystems such as peripheral system 120, user interface system 130, and data storage system 140 are shown separately from the data processing system 186 but can be stored completely or partially within the data processing system 186.

The peripheral system 120 can include one or more devices configured to provide digital content records to the processor 186. For example, the peripheral system 120 can include digital still cameras, digital video cameras, cellular phones, or other data processors. The processor 186, upon receipt of digital content records from a device in the peripheral system 120, can store such digital content records in the data storage system 140.

The user interface system 130 can include a mouse, a keyboard, another computer (connected, e.g., via a network or a null-modem cable), or any device or combination of devices from which data is input to the processor 186. The user interface system 130 also can include a display device, a processor-accessible memory, or any device or combination of devices to which data is output by the processor 186. The user interface system 130 and the data storage system 140 can share a processor-accessible memory.

In various aspects, processor 186 includes or is connected to communication interface 115 that is coupled via network link 116 (shown in phantom) to network 150. For example, communication interface 115 can include an integrated services digital network (ISDN) terminal adapter or a modem to communicate data via a telephone line; a network interface to communicate data via a local-area network (LAN), e.g., an Ethernet LAN, or wide-area network (WAN); or a radio to communicate data via a wireless link, e.g., WiFi or GSM. Communication interface 115 sends and receives electrical, electromagnetic or optical signals that carry digital or analog data streams representing various types of information across network link 116 to network 150. Network link 116 can be connected to network 150 via a switch, gateway, hub, router, or other networking device.

Processor 186 can send messages and receive data, including program code, through network 150, network link 116 and communication interface 115. For example, a server can store requested code for an application program (e.g., a JAVA applet) on a tangible non-volatile computer-readable storage medium to which it is connected. The server can retrieve the code from the medium and transmit it through network 150 to communication interface 115. The received code can be executed by processor 186 as it is received, or stored in data storage system 140 for later execution.

Data storage system 140 can include or be communicatively connected with one or more processor-accessible memories configured to store information. The memories can be, e.g., within a chassis or as parts of a distributed system. The phrase “processor-accessible memory” is intended to include any data storage device to or from which processor 186 can transfer data (using appropriate components of peripheral system 120), whether volatile or nonvolatile; removable or fixed; electronic, magnetic, optical, chemical, mechanical, or otherwise. Exemplary processor-accessible memories include but are not limited to: registers, floppy disks, hard disks, tapes, bar codes, Compact Discs, DVDs, read-only memories (ROM), erasable programmable read-only memories (EPROM, EEPROM, or Flash), and random-access memories (RAMs). One of the processor-accessible memories in the data storage system 140 can be a tangible non-transitory computer-readable storage medium, i.e., a non-transitory device or article of manufacture that participates in storing instructions that can be provided to processor 186 for execution.

In an example, data storage system 140 includes code memory 141, e.g., a RAM, and disk 143, e.g., a tangible computer-readable rotational storage device such as a hard drive. Computer program instructions are read into code memory 141 from disk 143. Processor 186 then executes one or more sequences of the computer program instructions loaded into code memory 141, as a result performing process steps described herein. In this way, processor 186 carries out a computer implemented process. For example, steps of methods described herein, blocks of the flowchart illustrations or block diagrams herein, and combinations of those, can be implemented by computer program instructions. Code memory 141 can also store data, or can store only code.

Various aspects described herein may be embodied as systems or methods. Accordingly, various aspects herein may take the form of an entirely hardware aspect, an entirely software aspect (including firmware, resident software, micro-code, etc.), or an aspect combining software and hardware aspects These aspects can all generally be referred to herein as a “service,” “circuit,” “circuitry,” “module,” or “system.”

Furthermore, various aspects herein may be embodied as computer program products including computer readable program code stored on a tangible non-transitory computer readable medium. Such a medium can be manufactured as is conventional for such articles, e.g., by pressing a CD-ROM. The program code includes computer program instructions that can be loaded into processor 186 (and possibly also other processors), to cause functions, acts, or operational steps of various aspects herein to be performed by the processor 186 (or other processor). Computer program code for carrying out operations for various aspects described herein may be written in any combination of one or more programming language(s), and can be loaded from disk 143 into code memory 141 for execution. The program code may execute, e.g., entirely on processor 186, partly on processor 186 and partly on a remote computer connected to network 150, or entirely on the remote computer.

The invention is inclusive of combinations of the aspects described herein. References to “a particular aspect” and the like refer to features that are present in at least one aspect of the invention. Separate references to “an aspect” (or “embodiment”) or “particular aspects” or the like do not necessarily refer to the same aspect or aspects; however, such aspects are not mutually exclusive, unless so indicated or as are readily apparent to one of skill in the art. The use of singular or plural in referring to “method” or “methods” and the like is not limiting. The word “or” is used in this disclosure in a non-exclusive sense, unless otherwise explicitly noted.

The invention has been described in detail with particular reference to certain preferred aspects thereof, but it will be understood that variations, combinations, and modifications can be effected by a person of ordinary skill in the art within the spirit and scope of the invention.

1. A system for steering asynchronous simulation data, comprising:
a) a computer processing unit;
b) a digital memory; and
c) an electronic display, the computer processing unit and the digital memory configured to:
d) receive a plurality of high-fidelity simulation data models that together form an asynchronous simulation pipeline;
e) determine low-fidelity approximations of the received simulation data models using local simulation proxies; and
f) display the approximations on a display for a user to enable the user to interactively configure a simulation run.

2. The system of claim 1, wherein the high fidelity simulation data models comprise powergrid simulations.

3. The system of claim 1, wherein the high fidelity simulation data models comprise highway traffic simulations.

4. The system of claim 1, wherein the high fidelity simulation data models comprise projected path and conditions of severe storms.

5. The system of claim 1, wherein the high fidelity simulation data models comprise powergrid simulations.

6. A method of steering asynchronous simulation data, comprising:
a) receiving a plurality of high-fidelity simulation data models that together form an asynchronous simulation pipeline;
b) determining low-fidelity approximations of the received simulation data models using local simulation proxies; and
c) displaying the approximations on a display for a user to enable the user to interactively configure a simulation run.

7. The method of claim 1, wherein the high fidelity simulation data models comprise powergrid simulations.

8. The method of claim 1, wherein the high fidelity simulation data models comprise highway traffic simulations.

9. The method of claim 1, wherein the high fidelity simulation data models comprise projected path and conditions of severe storms.

10. The method of claim 1, wherein the high fidelity simulation data models comprise powergrid simulations.
